(19) United States
(12) Patent Application Publication
(10) Pub. No.: US 2020/0111041 A1
(43) Pub. Date: Apr. 9, 2020

(54) SYSTEM AND METHOD FOR GENERATING AND MANAGING WORKFLOWS

(71) Applicant: StringBean Technologies, Valley Stream, NY (US)

(72) Inventors: Reuben I. Levine, Woodmere, NY (US); Shing Chung, Great Neck, NY (US)

(21) Appl. No.: 16/152,654

(22) Filed: Oct. 5, 2018

(51) Int. Cl. G06Q 10/06

(52) U.S. Cl. CPC G06Q 10/06316

(57) ABSTRACT

Systems and methods for generating workflows are provided herein. A request for a workflow is received from a user. The request includes workflow identification information. Based on the received request, a database that includes a plurality of workflows is accessed and the identification information from the received request is compared to identification information from the plurality of workflows. Based on the comparing, one or more of the plurality of workflows is selected. The requested workflow is generated from at least a portion of the one or more of the plurality of workflows and provided to the user.

### BACKGROUND

To become more efficient and competitive, businesses and industries have striven to capture and streamline workflows they use to operate and manage operations. In general, a workflow is a model of a process that includes a structured set of steps for producing a specific output. The creation of a workflow usually begins by manually defining steps and parameters of that process. However, such a creation method may be difficult or unwieldy. It may be cumbersome to think abstractly about steps that should be executed, the order in which they must be executed, or aspects of the steps that are unknown to a user based on, for example, the user's level of expertise with the software for creating a workflow and/or the user's level of experience for executing the workflow.

Conventional workflow management systems operate largely independently of one another, are dissimilar and disparate, and do not communicate directly. Sharing of knowledge and coordination of interdependent tasks are thus impracticable. As such, critical objectives, such as safety, security, occupant satisfaction, compliance with regulatory and industry standards are insufficiently addressed, and practices that enhance efficiency, automate administrative tasks, validate quality of work, improve customer satisfaction, and ultimately bolster profitability, are hindered. These systems also necessitate a high level of trust that the work will be performed with a certain degree of efficiency, quality and integrity, as auditing and verification is difficult. Because these systems do not enable seamless, automatic information exchange between entities that perform interrelated functions and tasks, redundancy of information entry and retrieval between interdependent participants is the norm. As a result, the coordination between mutually dependent organizations still requires a high degree of human interaction, and it is compromised by primitive, disjointed and unsophisticated methods. Thus, there is a need in the art for a tool that avoids the limitations of these conventional software tools.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

Examples of the disclosure are directed to a method for receiving a request for a workflow from a user, wherein the request includes workflow identification information. Based on the received request, a database that includes a plurality of workflows is accessed and the identification information from the received request is compared to identification information from the plurality of workflows. Based on the comparing, one or more of the plurality of workflows is selected. The requested workflow is generated from at least a portion of the one or more of the plurality of workflows and providing to the user.

Further examples of the disclosure are directed to a system that includes a memory, a computing device, and a server. The server includes one or more processors programmed to perform the operations for receiving a request for a workflow from a user, wherein the request includes workflow identification information. Based on the received request, a database that includes a plurality of workflows is accessed and the identification information from the received request is compared to identification information from the plurality of workflows. Based on the comparing, one or more of the plurality of workflows is selected. The requested workflow is generated from at least a portion of the one or more of the plurality of workflows and providing to the user.

Still further examples of the disclosure are directed to one or more computer-readable storage devices having computer-executable instructions stored thereon, that when executed by one or more processors, cause the one or more processors to perform operations that include receiving a request for a workflow from a user, wherein the request includes workflow identification information. Based on the received request, a database that includes a plurality of workflows is accessed and the identification information from the received request is compared to identification information from the plurality of workflows. Based on the comparing, one or more of the plurality of workflows is selected. The requested workflow is generated from at least a portion of the one or more of the plurality of workflows and providing to the user.

Many of the attendant features will be more readily appreciated as the same becomes better understood by reference to the following detailed description considered in connection with the accompanying drawings.

### BRIEF DESCRIPTION OF THE DRAWINGS

The present description will be better understood from the following detailed description read in light of the accompanying drawings, wherein:

FIG. 1 is a block diagram of a system for managing workflows;

FIGS. 2-5 are exemplary GUIs provided by the workflow management server described in FIG. 1.

FIG. 6 is an exemplary flow chart illustrating a method for generating workflows; and

Corresponding reference characters indicate corresponding parts throughout the drawings. In the figures, the systems are illustrated as schematic drawings. The drawings may not be to scale.

### DETAILED DESCRIPTION

The present disclosure provides a user-friendly interface that allows everyone in, for example, facilities management ecosystem (e.g., tradesman, vendors, engineers, building managers, and the like) real-time access to all stages of work and maintenance throughout a building. Using mobile technology, multiple parties can tap into a shared platform and have complete transparency into all work that is being planned, underway or completed. Unlike conventional systems and methods used for managing or generating workflows, aspects of the present disclosure enable a fully-configurable platform that streamlines and simplifies a workflow management and generation process by consolidating all critical activities into one central access point, with a common, universally-recognizable interface and set of protocols, enabling seamless integration of all communications, information capture and sharing, transactional, documentary, analytical, and compliance functions. Aspects of the present disclosure improve performance measurement, productivity evaluation, standards compliance, and work procedure completion and validation by introducing transparency and ease of information exchange associated with social networking to a single management ecosystem, facilitating true multidimensional collaboration.

In addition, the present disclosure provides systems and methods that automatically generate workflows based on, for example, a plurality of existing workflows stored in a database/memory, a type of job/task associated with the workflow, and workflow information, such as anchor points (e.g., a location, asset, legal case and/or matter, insurance claim or policy renewal, dispute, and/or marketing campaign to which the workflow is associated with) and workflow rules/parameters. This replaces a cumbersome manual effort of a user identifying all of the steps that should be executed, the order in which they must be executed, and/or all of the rules/regulations that must be adhered to when completing each step.

Having briefly described an overview of different examples, an exemplary operating environment suitable for implementing the disclosed processes of detecting anomalies is described below. The subject matter of the present disclosure is described with specificity herein to meet statutory requirements. However, the description itself is not intended to limit the scope of this patent. Rather, the inventors have contemplated that the claimed subject matter might also be embodied in other ways, to include different steps or combinations of steps similar to the ones described in this document, in conjunction with other present or future technologies. Moreover, although the terms “step” and/or “block” may be used herein to connote different elements of methods employed, the terms should not be interpreted as implying any particular order among or between various steps herein disclosed unless and except when the order of individual steps is explicitly described.

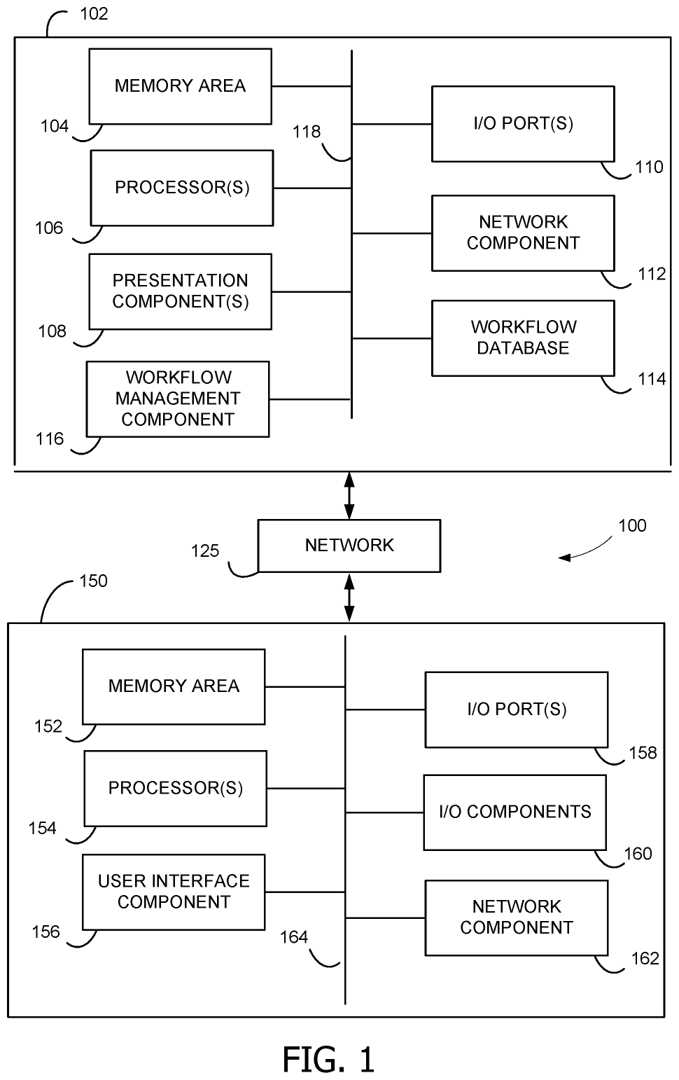

FIG. 1 is a block diagram illustrating an example workflow management system 100 for generating and managing workflows. The workflow management system 100 is one example of a suitable computing environment and is not intended to suggest any limitation as to the scope of use or functionality of the invention. Neither should the workflow management system 100 be interpreted as having any dependency or requirement relating to any one or combination of components/modules illustrated. Further, peripherals or components known in the art are not shown, but are operable with aspects of the disclosure. At least a portion of the functionality of the various elements in FIG. 1 may be performed by other elements in FIG. 1, or an entity (e.g., processor, web service, server, applications, computing device, etc.) not shown in FIG. 1.

The examples and embodiments disclosed herein may be described in the general context of computer code or machine-useable instructions, including computer-executable instructions such as program components, being executed by a computer or other machine, such as a personal data assistant or other handheld device. Generally, program components including routines, programs, objects, components, data structures, and the like, refer to code that performs particular tasks, or implement particular abstract data types. The disclosed examples may be practiced in a variety of system configurations, including personal computers, laptops, smart phones, mobile tablets, hand-held devices, consumer electronics, specialty computing devices, etc. The disclosed examples may also be practiced in distributed computing environments, where tasks are performed by remote-processing devices that are linked through a communications network. For example, a distributed computing environment may host cloud synthetics services. Some embodiments of synthetics services may provide synthetic 3D environments as well as rendering a surface in a synthetic scene.

The workflow management system 100 includes a workflow management server 102, which may be implented as a cloud-based server. However, aspects of the workflow management server 102 can be deployed in non-cloud application or any computing device or server that executes instructions to implement the operations and functionality associated with the computing device or server. The workflow management server 102 is communicatively coupled to a computing device 150 (e.g., tablet, smartphone, desktop, or laptop) via a network 125. The network 125 includes wireless and/or wired communication protocols and enables the user devices 104 to communicate with the workflow management server 102 and/or with other of the user devices 104.

The wofklow management server 102 includes a bus 118 that directly or indirectly couples the following: memory area 104, one or more processors 106, one or more presentation components 108, input/output (I/O) ports 110 which allow the workflow management server 102 to be logically coupled to other components/devices, a network component 112, a workflow database, and a workflow management component 116. The workflow management server 102 should not be interpreted as having any dependency or requirement related to any single component or combination of components illustrated therein. While the wofklow management server 102 is depicted as a single device, multiple computing devices may work together and share the depicted device resources. For instance, the memory 104 may be distributed across multiple devices, and the processor(s) 106 may provide housed on different devices, and so on.

The bus 118 represents what may be one or more busses (such as an address bus, data bus, or a combination thereof). Although the various blocks of FIG. 1 are shown with lines for the sake of clarity, in reality, delineating various components is not so clear, and metaphorically, the lines would more accurately be grey and fuzzy. For example, one may consider the presentation component 108, such as a display device to be an I/O component. Also, processors have memory. Such is the nature of the art, and the diagram of FIG. 1 is merely illustrative of a system or computing device that can be used in connection with one or more embodiments of the present disclosure. Distinction is not made between such categories as “workstation,” “server,” “laptop,” “hand-held device,” etc., as all are contemplated within the scope of FIG. 1 and the references herein to a “server” or “computing device.”

In some examples, the network component 112 includes a network interface card and/or computer-executable instructions (e.g., a driver) for operating the network interface card. Communication between the workflow management server 102 and other devices may occur using any protocol or mechanism over any wired or wireless connection. In some examples, the network component 112 is operable to communicate data over public, private, or hybrid (public and private) using a transfer protocol.

The memory area 104 may include any of the computer-readable media discussed herein. The memory area 104 may be used to store and access instructions configured to carry out the various operations disclosed herein. In some examples, the memory area 104 includes computer storage media in the form of volatile and/or nonvolatile memory, removable or non-removable memory, data disks in virtual environments, or a combination thereof. The memory area 104 and the workflow database 114 include any quantity of media associated with or accessible by the workflow management server 102. The memory area 104 and the workflow database 114 may be internal to the workflow management server 102, external to the workflow management server 102, (not shown), or both (not shown).

The workflow management server 102 is configured to operate using the workflow management component 116 to generate a workflow based at least in part on the pre-existing workflows stored in the workflow database and workflow identification information, such as anchorpoints, parameters/rules and polices that can be provided by the user or automatically determined based on the workflow identification information.

The workflow database 114 stores a plurality of the pre-existing workflows, as well as storing workflows as they are created (e.g., in real-time). These pre-existing workflows may be created by professionals in particular fields, engineers, organizations, crowdsourcing, companies, and the like. Examples of stored/pre-existing workflows are workflows directed to industry standard and code mandated safety, and preventative maintenance and break-fix diagnostic procedures. These pre-existing workflows may thus include: inspection workflows specific to standards issued by individual industry trade associations; inspection workflows specific to requirements promulgated by an authority having jurisdiction (AHJ); repair and maintenance workflows specific to particular equipment and machinery, as devised by the manufacturers; customize best-in-class standard operating procedures (SOPs) designed by individual ecosystem players that set themselves apart competitively. The stored workflows include a generic set of instructions and benchmarks that pertain to a particular task, follow a standard operating procedure (SOP), and/or adhere to the terms of a service level agreement (SLA). As described herein, the pre-existing workflows can be modified, for example, with site observations, task completion reports, and other content. Thus, a user may make their own workflows from scratch and/or alter pre-existing workflows, quickly design a report layout for customers and other stakeholders (e.g., a user or organization that defines rules for the workflow or that has an interest in the workflow being generated and executed a particular way, such as a user, an administrator, an employer, a building owner, a tenant, an engineer, a government, an agency/organization, and the like) that are automatically produced upon job completion, and readily release the workflows and reporting to a recipient (e.g., via the computing device 150).

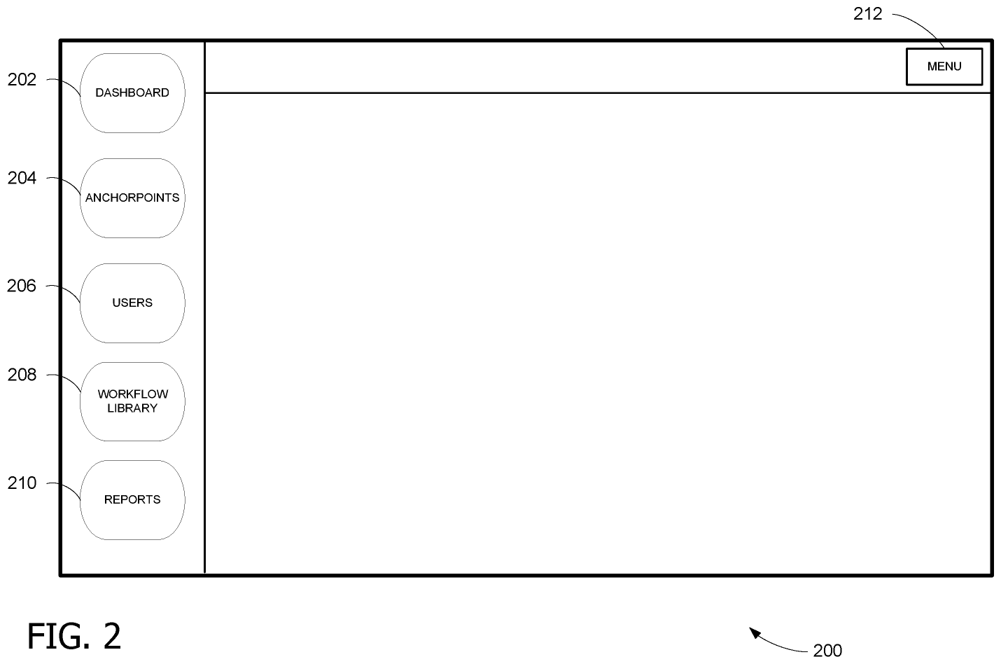

Turning back to FIG. 1, the processor(s) 106 may include any quantity of processing units that read data from various entities, such as the memory 104. Specifically, the processor(s) 106 are programmed to execute computer-executable instructions for implementing aspects of the disclosure. The instructions may be performed by the processor, by multiple processors within the wofklow management server 102, or by a processor external to the wofklow management server 102. In some examples, the processor(s) 106 are programmed to execute instructions such as those illustrated in the flowcharts discussed below and depicted in the accompanying drawings. Moreover, in some examples, the processor(s) 106 represent an implementation of analog techniques to perform the operations described herein. In some examples, the processor(s) 106 are transformed into a special purpose microprocessor by executing computer-executable instructions or by otherwise being programmed. For example, the workflow management component 116, when executed by the processor(s) 106, causes the processor(s) 106 to provide a workflow graphical user interface (GUI) (e.g., workflow GUI 200 shown in FIG. 2) via the presentation component 108. The presentation component 108 presents the workflow GUI 200 to a user on the computing device 150 via a user interface component 156 (e.g., a display) or other presentation components, such as a speaker or printing component etc. One skilled in the art will understand and appreciate that the workflow GUI 200 may be presented in a number of other ways, such as audibly through speakers.

As shown in FIG. 1, the computing device 150 includes a bus 164 that directly or indirectly couples the following: a memory area 152, one or more processors 154, the user interface component 156, I/O ports 158, I/O components 160, and a network component 162. The computing device 150 should not be interpreted as having any dependency or requirement related to any single component or combination of components illustrated therein.

The network component 162 enables exchanging of data between the computing device 150 and the workflow management server 102, a computer-readable media, or another computing device. For example, the workflow management server 102 may be coupled to the user device 150 via the network 125 and communications may occur using any protocol or mechanism over any wired or wireless connection. The ports 158 allow the computing device 150 to be logically coupled to other devices including the I/O components 160, some of which may be built in. Examples of the I/O components 160 include, for example but without limitation, a microphone, keyboard, mouse, joystick, game pad, satellite dish, scanner, printer, wireless device, etc.

In some examples, the network component 162 includes a network interface card and/or computer-executable instructions (e.g., a driver) for operating the network interface card. Communication between the computing device 150 and other devices may occur using any protocol or mechanism over any wired or wireless connection. In some examples, the network component 162 is operable to communicate data over public, private, or hybrid (public and private) using a transfer protocol, between devices wirelessly using short range communication technologies (e.g., near-field communication (NFC), BLUETOOTH® branded communications, or the like), or a combination thereof.

The user interface component 156 exchanges data between the workflow management server 102 and the computing device 150. For example, the user interface component 156 includes or is coupled to a presentation device (not shown) that is configured to present information, such as text, images, audio, video, graphics, alerts, and the like, to the user via the computing device 150. The user interface component 156 may include, without limitation, a display, a speaker, and/or a vibrating component. In at least some examples, the user interface component 156 is integrated with an input device in a common user interface configured to present information to the user and receive information from the user. For example, the common user-interface may include, without limitation, a capacitive touch screen display or a controller including a vibrating component.

In some examples, the computing device 150 detects voice input, user gestures or other user actions and provides a natural user interface (NUI). This user input may be used to author electronic ink, view content, select ink controls, play videos with electronic ink overlays and for other purposes. NUI technology enables a user to interact with the computing device 150 in a natural manner, free from artificial constraints imposed by input devices such as mice, keyboards, remote controls and the like. Examples of NUI technology that are provided in some examples include but are not limited to those relying on voice and/or speech recognition, touch and/or stylus recognition (touch sensitive displays), gesture recognition both on screen and adjacent to the screen, air gestures, head and eye tracking, voice and speech, vision, touch, gestures, and machine intelligence. Other examples of NUI technology that are used in some examples include intention and goal understanding systems, motion gesture detection systems using depth cameras (such as stereoscopic camera systems, infrared camera systems, red green blue (rgb) camera systems and combinations of these), motion gesture detection using accelerometers/gyroscopes, facial recognition, three dimensional (3D) displays, head, eye and gaze tracking, immersive augmented reality and virtual reality systems and technologies for sensing brain activity using electric field sensing electrodes (electro encephalogram (EEG) and related methods).

Although described in connection with the workflow management sever 102 and the computing device 150, examples of the disclosure are capable of implementation with numerous other general-purpose or special-purpose computing system environments, configurations, or devices. Examples of well-known computing systems, environments, and/or configurations that may be suitable for use with aspects of the disclosure include, but are not limited to, smart phones, mobile tablets, mobile computing devices, personal computers, server computers, hand-held or laptop devices, multiprocessor systems, gaming consoles, microprocessor-based systems, set top boxes, programmable consumer electronics, mobile telephones, mobile computing and/or communication devices in wearable or accessory form factors (e.g., watches, glasses, headsets, or earphones), network PCs, minicomputers, mainframe computers, distributed computing environments that include any of the above systems or devices, VR devices, holographic device, and the like. Such systems or devices may accept input from the user in any way, including from input devices such as a keyboard or pointing device, via gesture input, proximity input (such as by hovering), and/or via voice input.

Examples of the disclosure may be described in the general context of computer-executable instructions, such as program modules, executed by one or more computers or other devices in software, firmware, hardware, or a combination thereof. The computer-executable instructions may be organized into one or more computer-executable components or modules. Generally, program modules include, but are not limited to, routines, programs, objects, components, and data structures that perform particular tasks or implement particular abstract data types. Aspects of the disclosure may be implemented with any number and organization of such components or modules. For example, aspects of the disclosure are not limited to the specific computer-executable instructions or the specific components or modules illustrated in the figures and described herein. Other examples of the disclosure may include different computer-executable instructions or components having more or less functionality than illustrated and described herein. In examples involving a general-purpose computer, aspects of the disclosure transform the general-purpose computer into a special-purpose computing device when configured to execute the instructions described herein.

By way of example and not limitation, computer readable media comprise computer storage media and communication media. Computer storage media include volatile and nonvolatile, removable and non-removable memory implemented in any method or technology for storage of information such as computer readable instructions, data structures, program modules, or the like. Computer storage media are tangible and mutually exclusive to communication media. Computer storage media are implemented in hardware and exclude carrier waves and propagated signals. Computer storage media for purposes of this disclosure are not signals per se. Exemplary computer storage media include hard disks, flash drives, solid-state memory, phase change random-access memory (PRAM), static random-access memory (SRAM), dynamic random-access memory (DRAM), other types of random-access memory (RAM), read-only memory (ROM), electrically erasable programmable read-only memory (EEPROM), flash memory or other memory technology, compact disk read-only memory (CD-ROM), digital versatile disks (DVD) or other optical storage, magnetic cassettes, magnetic tape, magnetic disk storage or other magnetic storage devices, or any other non-transmission medium that can be used to store information for access by a computing device. In contrast, communication media typically embody computer readable instructions, data structures, program modules, or the like in a modulated data signal such as a carrier wave or other transport mechanism and include any information delivery media.

With reference now to FIG. 2, the workflow GUI 200 is provided. The workflow GUI 200 is built on a centralized platform that provides the workflow GUI 200 as a common GUI for interfacing with the workflow management server 102. The workflow GUI 200 provides the functionality and resources needed for all types of users, such as, stakeholders mandating and/or desiring specific protocols, and the users who execute the workflow. The platform that supports the workflow GUI 200 ensures ease of adoption and functional management. Through a single, multifaceted workflow such as the workflow GUI 200, a user can conduct: voice, video, text and email communications, free flow capture, sharing, storing and aggregation of information in a form of photos, videos and voice commands. A series of these data points can be unbundled and repackaged and customized for use by subsequent users.

The workflow GUI 200 may include a plurality of selectable items (e.g., dashboard 202, anchorpoints 204, users 206, workflow(s) 208, reports 210, and menu 212), which may be selected by a user when the workflow GUI 200 is presented on the user interface component 156 by the presentation component 108. For example, the reports 210 provides highly flexible and intuitive reports. The reports 210 enables compliance reports to be populated and produced immediately upon completion of a workflow or upon a completion of each step in the workflow in real-time. The reports 210 can also provide validation and documentation of all activities, for example, repairs, maintenance, installation, inspections, and measurement and reading of various system attributes (e.g., temperature, pressure, and humidity). Embodiments described herein can utilize Bluetooth connectivity of the computing device 150 to communicate between measurement devices and gauges to obtain these readings. The reports 210 can also provide human resource performance and productivity monitoring and evaluation, equipment, parts and materials procurement and other transactional activity.

In addition to utilizing Bluetooth connectivity, the platform that is provided by the workflow management server 102 enables users to choose to incorporate radio-frequency identification (RFID) and/or Quick Response code (QR) functionality into their workflows that are identified/read by the computing device 150. An RFID/QR tag, or asset tag, is a chip that is affixed to an object and contains information pertaining to that object. RFID/QR tags are commonly used to identify and track objects, such as inventory. As it pertains to the workflows described herein, RFID/QR identification employs equipment tags and/or process tags that support specific workflows. The computing device 150, being a Bluetooth-enabled handheld device, can deposit information onto, and retrieve information from, RFID/QR tags. By using RFID/QR tagging, a temporary marker can be placed upon a piece of equipment in order to prompt and direct follow-up activity upon executing the workflow. A technician, administer, and/or analyst may determine that further action must be taken by another party, and affixes an RFID/QR tag with a unique “attribute code” assigned to the workflow attached to that determination. A subsequent visitor, who has been granted tag specific credentials, reads the attribute code with the computing device 150 and retrieves the corresponding workflow from the workflow management server 102. Permanent markers may also be placed throughout mechanical systems and floor plans during construction. With permanent markers in place throughout a property, a user identifies and finds relevant places using the computing device 150. Tamper-proof process markers are used to support and ensure the thoroughness of a routine inspection mandated by an AHJ, a standard operating procedure (SOP) required by a building engineer, or a diagnostic test recommended by an equipment manufacturer to ensure that a system is performing to specifications.

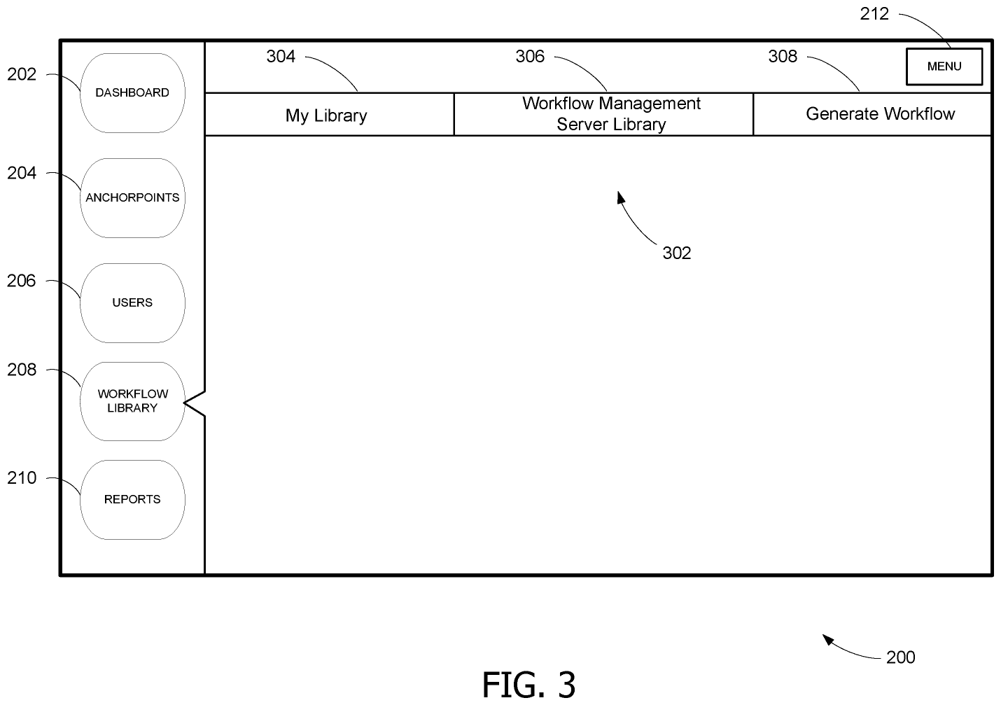

With reference back to FIG. 2, upon a selection of the workflow(s) 208 in the workflow GUI 200, the user is presented with a toolbar 302 shown in FIG. 3. The toolbar 302 includes a plurality of options, such as my library 304, workflow management server library 306, and generate workflow 308. The my library 304 may include one or more workflows created by the user, generated on behalf of the user, or workflows the user has saved from the workflow database 114, which can be accessed using the workflow management server library 306, which provides access to the workflow database 114. The generate workflow 308, when selected, provides the user with various ways in which to generate a workflow as described in further detail below.

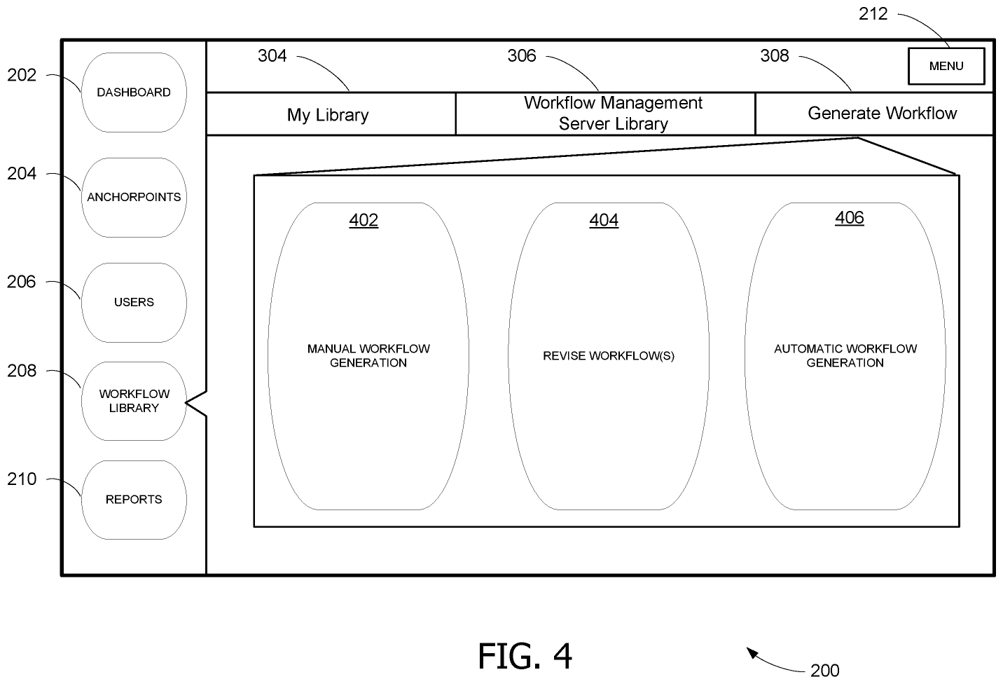

With reference now to FIG. 4, upon a selection of the generate workflow 308, the user is presented with a plurality of options for generating a workflow. In the embodiment shown in FIG. 4, a user is presented with an option for manual workflow generation 402, revise workflow(s) 404, and automatic workflow generation 406. The selection of the manual workflow generation 402 enables a user to create flow diagrams, wherein each step in the flow diagram is a step in the workflow being created. Not only can the user define the steps and the order of the steps within the workflow, the user has the ability to also define any rules, policies, or parameters to be applied to these workflows.

When the revise workflow(s) 404 is selected, a user is enabled to access a workflow stored in the workflow database 114 or provide a workflow that is not stored in the workflow database 114. The user can then request that the workflow be examined by the workflow management component 116 to identify any updates to the steps, rules, policies, or parameters to the current workflow presented by the user. The workflow management component 116 may identify these updates by searching the workflow database 114 for similar workflows (e.g., workflows created by the same user, workflows with corresponding stakeholders, workflows with corresponding anchorpoints, or workflows that are directed to the same or similar process) to determine if there are differences that should be added/removed from the current workflow presented by the user. The workflow management component 116 may highlight proposed changes in the workflow GUI 200, or automatically make the identified changes to the current workflow without user intervention.

For example, the user may submit a completed workflow as a request for a workflow, but the identification information included with the request includes, for example, a specific anchorpoint, such as a specific location the workflow is being executed. Thus, while the workflow is complete, an updated workflow can be generated that includes updates as they pertain to the particular location. For example, a user may use a particular workflow in a particular city/state; however, the user is wanting to execute the particular workflow in a different city/state. As such, the request for the workflow would include the new city/state and provide a new/updated workflow (e.g., the generated workflow) based on law/rules/regulations that are particular to that city/state or the workflow management component 116 may remove certain rules/parameters from the workflow as the new city/state my not require what the previous city/state required in the workflow.

In other embodiments, the requested workflow (e.g., a request for an updated workflow) may not be a request based on a known anchorpoint, but a request for updates a user may be unaware of. For example, if the user is executing the requested workflow associated with one or more stakeholders, the workflow management component 116 may generate a workflow based on updates the one or more stakeholders have included in other workflows stored in the workflow database 114. In this example, the stakeholders name's (e.g., name of a company, the name of the agency, name of the owner or tenant of the building) may be included in the workflow identification information so that the workflow management component 116 can cross-reference this information with the workflows stored in the workflow database 114. An end result of the user requested a revised workflow through the revise workflow(s) 404, is that the user is automatically provided with a most up-to-date workflow without requiring the user to manually check for these updates and/or apply revisions to the requested workflow being updated.

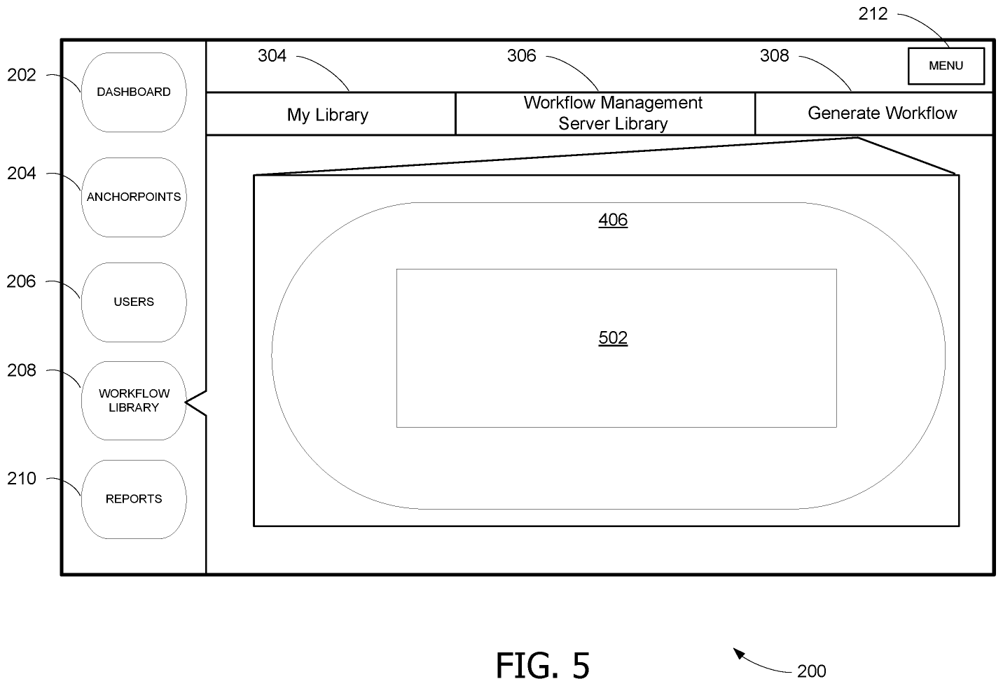

When the automatic workflow generation 406 is selected in FIG. 4, the user is presented with window 502 shown in FIG. 5 for entering a request for a workflow. In the embodiments described herein, the request for the workflow includes workflow identification information that is provided by the user. In some embodiments, the identification information includes a type of workflow being requested. In one example, this could be one or more terms the user provides that bests describes the workflow being requested. Thus, a user could provide a single term or a full description of the type of workflow being requested that can be used as a search query by the workflow management component 116. In addition, the identification information can include one or more anchorpoints and/or a set of policies the requested workflow is to be governed by. The set of policies may include rules, regulations, a list of essential steps in the requested workflow (e.g., steps that are required or skippable), dependencies for each step in the requested workflow, guidelines for the requested workflow based on a location the requested workflow is to be executed, a type of user to execute each of the steps in the requested workflow, parameters (e.g., required steps, budget restraints, safety precautions, required credentials for a user, picture/video confirmation for particular steps, among others), which may be parameters provided by one or more stakeholders associated with the user making the request.

In some embodiments, based on the received request for the workflow, the workflow management component 116 compares the identification information with identification information associated with the plurality of workflows in the workflow database 114 and ranks a list of workflows from the plurality of workflows in the workflow database 114 that best satisfy the identification information. A score, representing a measure of how well each of the workflows in the list of workflows is algorithmically generated by the workflow management component 116. The workflow management component 116 separates the identification information into search terms, and using statistical information about an occurrence of individual terms in the plurality of workflows in the workflow database 114, one or more of the plurality of workflows are selected based on their rank according to their corresponding scores, and can be presented to the user as the requested workflow.

In some situations, the selected one or more workflows may not be an entire match for the requested workflow. For example, the selected one or more workflows may not include all of the identification information in the requested workflow. That is, the selected one or more workflows may not include one or more of the policies, rules, or regulations the user requested. Further, the selected one or more workflows may not include one or more steps the user identified in the requested workflow, one or more dependencies for the steps in the requested workflow, one or more of the guidelines for the requested workflow (e.g., based on one or more anchorpoints associated with the requested workflow is to be executed), a requirement for the type of user to execute each of the steps in the requested workflow, and/or one or more parameters for the requested workflow. As such, the workflow management component 116 identifies portions of the requested workflow (e.g., based on the workflow identification information and/or one or more stakeholders and anchorpoints associated with the requested workflow) that are missing from the one or more selected workflows and automatically adds these missing portions to the requested workflow.

In one example, when the workflow management component 116 generates a workflow that is missing information (e.g., is not complete as described above), the workflow management component 116 may send a request to the user via the workflow GUI 200 to manually input the needed information to complete the requested workflow, or simply provide the user with an incomplete workflow. In another embodiment, the workflow management component 116 submits the incomplete workflow to other users to complete. In this example, the “other users” may be users (e.g., engineers or other professionals) associated with the type of requested workflow or they may be a group of users for crowdsourcing.

In another example, the workflow management component 116 combines the selected one or more incomplete workflows to generate a completed version of the requested workflow. Still further, if combining the selected one or more workflows does not address the missing portions of the requested workflow, the workflow management component 116 can perform an additional search in the workflow database 114 that is specific to the missing portions of the requested workflow. As explained above, these missing portions may be steps in the requested workflow or missing parameters, guidelines, rules, and/or policies. These missing portions of the requested workflow may be obtained from workflows stored in the workflow database 114 even though these workflows were not selected initially by the workflow management component 116. Once the workflow management component 116 has obtained all of the needed information to complete the requested workflow, the workflow management component 116 generates the requested workflow. After the workflow management component 116 has generated the requested workflow, the generated workflow is presented to the user in the workflow GUI 200 on the user device 150.

In one embodiment, the identification information may include information that indicates the requested workflow is to be multi-dimensional. A multi-dimensional workflow is a non-linear workflow that provides one or more workflows within a workflow. For example, based on a user's input during an execution of a step with a multi-dimensional workflow, the multi-dimensional workflow launches an additional workflow. Thus, the identification information may include an indication as to which steps in the multi-dimensional workflow are decision steps that, based on a user's input (e.g., a psi reading, budget, malfunctioning or missing part) that is outside of a threshold or that indicates a new workflow needs to be followed, enables a new/different workflow to be launched based on that input (e.g., the new/different workflow may include corrective measures to address an alert/alarm). In some embodiments, the decision making step in the generated workflow may include a multiple choice set of inputs in which each answer/input launches an additional workflow that is specific to that answer.

In some embodiments, a requested workflow may include a plurality of stakeholders, with each of the plurality of stakeholders being associated with a subset of the steps in the requested workflow. For example, the requested workflow may be a request for a workflow to install a fire alarm in a building. Possible stakeholders in this example are, the owners of the building, a tenant leasing space in the building, the National Fire Protection Agency, a local city/state jurisdiction, the employer of the user that will be completing the workflow, and insurance companies for the owner of the building and the tenant. Each of these stakeholders may have requirements (e.g., rules and steps) that need or should be included in the requested workflow. Some of these steps may be common to one or more of the stakeholders while other steps may be specific to a particular stakeholder. The workflow management component 116 identifies rules/steps among the plurality of stakeholders and generates the requested workflow, which includes each of the steps/rules required by each of the plurality of stakeholders.

Expanding on the example above, each stakeholder may have access to workflows generated by them or on their behalf. However, in the example above, multiple stakeholders are associated with a single workflow. Thus, each stakeholder may have the ability to only access the rules/steps the particular stakeholder is associated with. In addition, each stakeholder may only receive updates and/or reports that are specific to the steps associated with the particular stakeholder. This enables each stakeholder the ability to provide information in a workflow the stakeholder does not want shared with other stakeholders.

In another embodiment, one of the stakeholders in the example above may have a conflict with one or more of the rules/steps required by another stakeholder. For example, upon a completion of installation of the fire alarm, one stakeholder may require a licensed fire inspector to review the installation and sign off on the installation prior to the workflow being complete. However, another stakeholder may require the workflow to be complete once the fire alarm is installed (e.g., without inspection) to enable, for example, an invoice to be generated as soon as possible. When conflicts arise between rules/steps in a workflow, these rules/steps may be flagged and presented to the user for resolution. As such, a user may make a decision on which rules/steps to follow in an event of a conflict, and this decision is documented in the generated workflow and/or report. In another example, the workflow management component 116 may automatically determine which rules/steps to follow in an event of a conflict based on a primary stakeholder (e.g., the stakeholder identified by the user as the primary stakeholder or the stakeholder that has historically been determined as the primary stakeholder) for that particular rule/step or for the entire workflow.

The workflow identification information may be input by the user upon making the request for the workflow (as described above) and/or is metadata or code within an existing workflow the user is submitting with the request. In addition, when making a request for a workflow, the user may fill out a questionnaire that is presented in the window 502 in FIG. 5, and any information input in the questionnaire may be used as workflow identification information for generating the requested workflow. In this example, questionnaires may be categorized based on one or more of the identification information, such as a type of workflow, the user, possible stakeholders, etc. Thus, a particular questionnaire may be presented to the user based on a set of information the user provides. In one embodiment, multiple questionnaires may be presented to the user in order to gather as much identification information as possible, and more specifically, identification information that is associated with the requested workflow, which enables the workflow management component 116 to generate a more accurate workflow requested by the user.

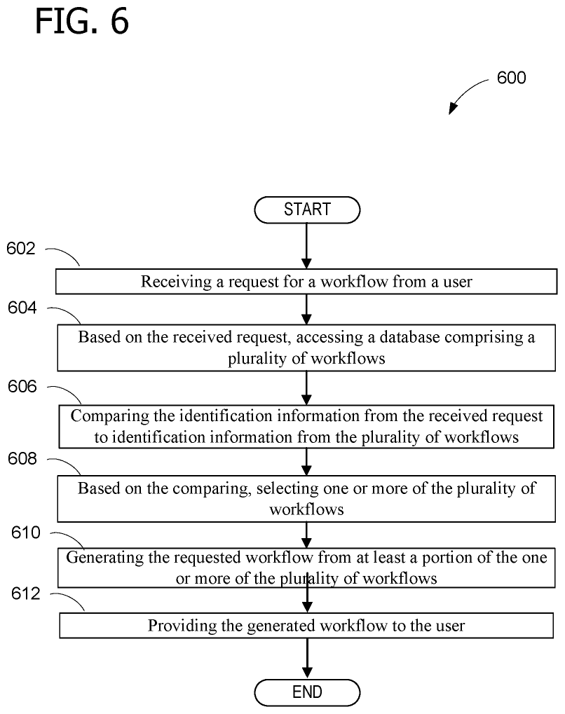

With reference now to FIG. 6, a flow chart illustrating one embodiment of a method 600 for generating a workflow is provided. The method 600 is performed by processing logic that may comprise hardware (circuitry, dedicated logic, etc.), software (such as is run on a general purpose computer system or a dedicated machine), or a combination of both.

The method 600 begins at 602 by receiving a request for a workflow from a user, wherein the request includes workflow identification information. In one embodiment, the identification information comprises a description of a type of the requested workflow and/or a list of essential steps in the requested workflow. In another embodiment, the identification information further identifies one or more stakeholders associated with the requested workflow, one or more anchorpoints associated with the requested workflow, and/or one or more policies that include one or more of the following: dependencies for each step in the requested workflow, guidelines for the requested workflow, a type of user to execute each of the steps in the requested workflow, and parameters for the requested workflow, each of which may be based on the stakeholders and anchorpoints associated with the requested workflow or the user. The request may also include a partial workflow, and wherein generating the requested workflow from the at least portion of the one or more of the plurality of workflows includes combining the partial workflow with the at least portion of the one or more of the plurality of workflows. Still further, the request may include a completed workflow, but the request may be specific to a request for an updated workflow. In this embodiment, the identification information can be obtained from the workflow in the request.

At 604, based on the received request, a database (e.g., the workflow database 114) comprising a plurality of workflows is accessed. At 606, the identification information from the received request is compared to identification information from the plurality of workflows stored in the workflow database 114. In this embodiment, a list of workflows from the database 114 are ranked according to how well these workflows satisfy the identification information in the request. A score, representing a measure of how well each of the workflows in the list of workflows is algorithmically generated (e.g., by the workflow management component 116). The identification information in the request is separated into search terms, and using statistical information about an occurrence of individual terms in the plurality of workflows in the workflow database 114, one or more of the plurality of workflows are identified based on their rank according to their corresponding scores. At 608, based on the comparing, one or more of the plurality of workflows (e.g., the identified workflows) stored in the workflow database 114 are selected.

At 610, the requested workflow is generated from at least a portion of the one or more of the plurality of workflows. For example, the workflow management component 116 combines the selected one or more workflows to generate a completed version of the requested workflow. However, if combining the selected one or more workflows does not address any missing portions of the requested workflow, the workflow management component 116 can perform an additional search in the workflow database 114 that is specific to the missing portions of the requested workflow. As explained above, these missing portions may be steps in the requested workflow or missing parameters, guidelines, rules, and/or policies. These missing portions of the requested workflow may be obtained from workflows stored in the workflow database 114 even though these workflows were not selected initially by the workflow management component 116. Once the workflow management component 116 has finished obtaining the additional information the workflow management component 116 generates the requested workflow.

At 612, the generated workflow is provided to the user. In one embodiment, the generated workflow identifies one or more steps that are incomplete. In this embodiment, a request is sent to the user for additional information to complete the one or more steps that are incomplete. The additional information is received from the user, and thereafter, based on the additional information, a revised generated workflow that includes the one or more steps as completed is presented to the user. In addition, one or more recommendations on how to complete the one or more steps that are incomplete is also provided to the user. For example, the generated workflow may be directed to changing the oil on a car. However, for this particular car, the workflow management component 116 does not have any information on what type of oil to use. As such, the workflow management component 116 requests the user to provide the type of oil to use before completing the workflow. In another embodiment, the workflow management component 116 may recommend a particular oil based on other workflows directed to oil changes that include cars most similar to the particular car. Thus, after the user either provides the type of oil or accepts recommendation made by the workflow management component 116, the workflow is generated.

Alternatively, or in addition to the other examples described herein, examples include any combination of the following:

A method comprising:

receiving a request for a workflow from a user, the request comprising workflow identification information,

based on the received request, accessing a database comprising a plurality of workflows;

comparing the identification information from the received request to identification information from the plurality of workflows;

based on the comparing, selecting one or more of the plurality of workflows;

generating the requested workflow from at least a portion of the one or more of the plurality of workflows; and

providing the generated workflow to the user.

The method as described above, wherein the identification information comprises a description of a type of the requested workflow.

The method as described above, wherein the identification information further comprises a list of essential steps in the requested workflow.

The method as described above, wherein the identification information further comprise polices based on one or more anchorpoints and stakeholders associated with the requested workflow or the user, wherein the polices include one or more of the following: dependencies for each step in the requested workflow, guidelines for the requested workflow, a type of user to execute each of the steps in the requested workflow, and parameters for the requested workflow.

The method as described above, wherein the request further comprises a partial workflow, and wherein generating the requested workflow from the at least portion of the one or more of the plurality of workflows comprises combining the partial workflow with the at least portion of the one or more of the plurality of workflows.

The method as described above, wherein the generated workflow identifies one or more steps that are incomplete, and wherein the method further comprises:

sending a request to the user for additional information to complete the one or more steps that are incomplete;

receiving, from the user, the additional information; and

providing, based the additional information, a revised generated workflow that includes the one or more steps as completed.

The method as described above, further comprising providing the user with one or more recommendations on how to complete the one or more steps that are incomplete.

A system comprising:

a memory comprising a plurality of workflows;

a computing device; and

a server comprising one or more processors programmed to perform operations comprising:

receiving a request for a workflow from the computing device, the request comprising workflow identification information;

based on the request, comparing the identification information from the received request to identification information from the plurality of workflows;

based on the comparing, selecting one or more of the plurality of workflows;

generating the requested workflow from at least a portion of the one or more of the plurality of workflows; and

providing the generated workflow to the computing device for display to a user.

The system as described above, wherein the identification information comprises a description of a type of the requested workflow.

The system as described above, wherein the identification information further comprises a list of essential steps in the requested workflow.

The system as described above, wherein the identification information further comprise polices based on one or more anchorpoints and stakeholders associated with the requested workflow or the user, wherein the polices include one or more of the following: dependencies for each step in the requested workflow, guidelines for the requested workflow, a type of user to execute each of the steps in the requested workflow, and parameters for the requested workflow.

The system as described above, wherein the request further comprises a partial workflow, and wherein generating the requested workflow from the at least portion of the one or more of the plurality of workflows comprises combining the partial workflow with the at least portion of the one or more of the plurality of workflows.

The system as described above, wherein the generated workflow identifies one or more steps that are incomplete, and wherein the one or more processors are further programmed to perform the following operations:

sending a request to the computing device for additional information to complete the one or more steps that are incomplete;

receiving, from computing device, the additional information; and

providing, based the additional information, a revised generated workflow that includes the one or more steps as completed to the computing device.

The system as described above, wherein the one or more processors are further programmed to perform providing the computing device with one or more recommendations on how to complete the one or more steps that are incomplete.

One or more computer-readable storage devices having computer-executable instructions stored thereon, that when executed by one or more processors, cause the one or more processors to perform the following operations:

receiving a request for a workflow from a user, the request comprising workflow identification information,

based on the received request, accessing a database comprising a plurality of workflows;

comparing the identification information from the received request to identification information from the plurality of workflows;

based on the comparing, selecting one or more of the plurality of workflows;

generating the requested workflow from at least a portion of the one or more of the plurality of workflows; and

providing the generated workflow to the user.

The one or more computer-readable storage devices as described above, wherein the identification information comprises a description of a type of the requested workflow.

The one or more computer-readable storage devices of as described above, wherein the identification information further comprises a list of essential steps in the requested workflow.

The one or more computer-readable storage devices of as described above, wherein the identification information further comprise polices based on one or more anchorpoints and stakeholders associated with the requested workflow or the user, wherein the polices include one or more of the following: dependencies for each step in the requested workflow, guidelines for the requested workflow, a type of user to execute each of the steps in the requested workflow, and parameters for the requested workflow.

The one or more computer-readable storage devices as described above, wherein the request further comprises a partial workflow, and wherein generating the requested workflow from the at least portion of the one or more of the plurality of workflows comprises combining the partial workflow with the at least portion of the one or more of the plurality of workflows.

The one or more computer-readable storage devices as described above, wherein the generated workflow identifies one or more steps that are incomplete, and wherein the one or more processors further perform operations comprising:

sending a request to the user for additional information to complete the one or more steps that are incomplete;

receiving, from the user, the additional information; and

providing, based the additional information, a revised generated workflow that includes the one or more steps as completed.

Although described in connection with an exemplary computing system environment, examples of the disclosure are capable of implementation with numerous other general purpose or special purpose computing system environments, configurations, or devices.

Examples of well-known computing systems, environments, and/or configurations that may be suitable for use with aspects of the disclosure include, but are not limited to, mobile or portable computing devices (e.g., smartphones), personal computers, server computers, hand-held (e.g., tablet) or laptop devices, multiprocessor systems, gaming consoles or controllers, microprocessor-based systems, set top boxes, programmable consumer electronics, mobile telephones, mobile computing and/or communication devices in wearable or accessory form factors (e.g., watches, glasses, headsets, or earphones), network PCs, minicomputers, mainframe computers, distributed computing environments that include any of the above systems or devices, and the like. In general, the disclosure is operable with any device with processing capability such that it can execute instructions such as those described herein. Such systems or devices may accept input from the user in any way, including from input devices such as a keyboard or pointing device, via gesture input, proximity input (such as by hovering), and/or via voice input.

Examples of the disclosure may be described in the general context of computer-executable instructions, such as program modules, executed by one or more computers or other devices in software, firmware, hardware, or a combination thereof. The computer-executable instructions may be organized into one or more computer-executable components or modules. Generally, program modules include, but are not limited to, routines, programs, objects, components, and data structures that perform particular tasks or implement particular abstract data types. Aspects of the disclosure may be implemented with any number and organization of such components or modules. For example, aspects of the disclosure are not limited to the specific computer-executable instructions or the specific components or modules illustrated in the figures and described herein. Other examples of the disclosure may include different computer-executable instructions or components having more or less functionality than illustrated and described herein.

In examples involving a general-purpose computer, aspects of the disclosure transform the general-purpose computer into a special-purpose computing device when configured to execute the instructions described herein.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

It will be understood that the benefits and advantages described above may relate to one embodiment or may relate to several embodiments. The embodiments are not limited to those that solve any or all of the stated problems or those that have any or all of the stated benefits and advantages. It will further be understood that reference to ‘an’ item refers to one or more of those items.

The term “comprising” is used in this specification to mean including the feature(s) or act(s) followed thereafter, without excluding the presence of one or more additional features or acts.

In some examples, the operations illustrated in the figures may be implemented as software instructions encoded on a computer readable medium, in hardware programmed or designed to perform the operations, or both. For example, aspects of the disclosure may be implemented as a system on a chip or other circuitry including a plurality of interconnected, electrically conductive elements.

The order of execution or performance of the operations in examples of the disclosure illustrated and described herein is not essential, unless otherwise specified. That is, the operations may be performed in any order, unless otherwise specified, and examples of the disclosure may include additional or fewer operations than those disclosed herein. For example, it is contemplated that executing or performing a particular operation before, contemporaneously with, or after another operation is within the scope of aspects of the disclosure.

When introducing elements of aspects of the disclosure or the examples thereof, the articles “a,” “an,” “the,” and “said” are intended to mean that there are one or more of the elements. The terms “comprising,” “including,” and “having” are intended to be inclusive and mean that there may be additional elements other than the listed elements. The term “exemplary” is intended to mean “an example of.” The phrase “one or more of the following: A, B, and C” means “at least one of A and/or at least one of B and/or at least one of C.”

Having described aspects of the disclosure in detail, it will be apparent that modifications and variations are possible without departing from the scope of aspects of the disclosure as defined in the appended claims. As various changes could be made in the above constructions, products, and methods without departing from the scope of aspects of the disclosure, it is intended that all matter contained in the above description and shown in the accompanying drawings shall be interpreted as illustrative and not in a limiting sense.

What is claimed is:

1. A method comprising:
receiving a request for a workflow from a user, the request comprising workflow identification information,
based on the received request, accessing a database comprising a plurality of workflows;
comparing the identification information from the received request to identification information from the plurality of workflows;
based on the comparing, selecting one or more of the plurality of workflows;
generating the requested workflow from at least a portion of the one or more of the plurality of workflows; and
providing the generated workflow to the user.

2. The method of claim 1, wherein the identification information comprises a description of a type of the requested workflow.

3. The method of claim 2, wherein the identification information further comprises a list of essential steps in the requested workflow.

4. The method of claim 2, wherein the identification information further comprises polices based on one or more anchorpoints and stakeholders associated with the requested workflow or the user, wherein the polices include one or more of the following: dependencies for each step in the requested workflow, guidelines for the requested workflow, a type of user to execute each of the steps in the requested workflow, and parameters for the requested workflow.

5. The method of claim 1, wherein the request further comprises a partial workflow, and wherein generating the requested workflow from the at least portion of the one or more of the plurality of workflows comprises combining the partial workflow with the at least portion of the one or more of the plurality of workflows.

6. The method of claim 1, wherein the generated workflow identifies one or more steps that are incomplete, and wherein the method further comprises:
sending a request to the user for additional information to complete the one or more steps that are incomplete;
receiving, from the user, the additional information; and
providing, based on the additional information, a revised generated workflow that includes the one or more steps as completed.

7. The method of claim 6, further comprising providing the user with one or more recommendations on how to complete the one or more steps that are incomplete.

8. A system comprising:
a memory comprising a plurality of workflows;
a computing device; and
a server comprising one or more processors programmed to perform operations comprising:
receiving a request for a workflow from the computing device, the request comprising workflow identification information;
based on the request, comparing the identification information from the received request to identification information from the plurality of workflows;
based on the comparing, selecting one or more of the plurality of workflows;
generating the requested workflow from at least a portion of the one or more of the plurality of workflows; and
providing the generated workflow to the computing device for display to a user.

9. The system of claim 8, wherein the identification information comprises a description of a type of the requested workflow.

10. The system of claim 9, wherein the identification information further comprises a list of essential steps in the requested workflow.

11. The system of claim 9, wherein the identification information further comprises polices based on one or more anchorpoints and stakeholders associated with the requested workflow or the user, wherein the polices include one or more of the following: dependencies for each step in the requested workflow, guidelines for the requested workflow, a type of user to execute each of the steps in the requested workflow, and parameters for the requested workflow.

12. The system of claim 8, wherein the request further comprises a partial workflow, and wherein generating the requested workflow from the at least portion of the one or more of the plurality of workflows comprises combining the partial workflow with the at least portion of the one or more of the plurality of workflows.

13. The system of claim 8, wherein the generated workflow identifies one or more steps that are incomplete, and wherein the one or more processors are further programmed to perform the following operations:
sending a request to the computing device for additional information to complete the one or more steps that are incomplete;
receiving, from computing device, the additional information; and
providing, based the additional information, a revised generated workflow that includes the one or more steps as completed to the computing device.

14. The system of claim 13, wherein the one or more processors are further programmed to perform providing the computing device with one or more recommendations on how to complete the one or more steps that are incomplete.

15. One or more computer-readable storage devices having computer-executable instructions stored thereon, that when executed by one or more processors, cause the one or more processors to perform the following operations:
receiving a request for a workflow from a user, the request comprising workflow identification information,
based on the received request, accessing a database comprising a plurality of workflows;
comparing the identification information from the received request to identification information from the plurality of workflows;
based on the comparing, selecting one or more of the plurality of workflows;
generating the requested workflow from at least a portion of the one or more of the plurality of workflows; and
providing the generated workflow to the user.

16. The one or more computer-readable storage devices of claim 15, wherein the identification information comprises a description of a type of the requested workflow.

17. The one or more computer-readable storage devices of claim 16, wherein the identification information further comprises a list of essential steps in the requested workflow.

18. The one or more computer-readable storage devices of claim 16, wherein the identification information further comprises polices based on one or more anchorpoints and stakeholders associated with the requested workflow or the user, wherein the polices include one or more of the following: dependencies for each step in the requested workflow, guidelines for the requested workflow, a type of user to execute each of the steps in the requested workflow, and parameters for the requested workflow.

19. The one or more computer-readable storage devices of claim 15, wherein the request further comprises a partial workflow, and wherein generating the requested workflow from the at least portion of the one or more of the plurality of workflows comprises combining the partial workflow with the at least portion of the one or more of the plurality of workflows.

20. The one or more computer-readable storage devices of claim 15, wherein the generated workflow identifies one or more steps that are incomplete, and wherein the one or more processors further perform operations comprising:
sending a request to the user for additional information to complete the one or more steps that are incomplete;
receiving, from the user, the additional information; and
providing, based the additional information, a revised generated workflow that includes the one or more steps as completed.
